(19) United States
(12) Patent Application Publication
(10) Pub. No.: US 2008/0238090 A1
(43) Pub. Date: Oct. 2, 2008

(54) Fitting With Lubricated Ferrule

(75) Inventor: Peter C. Williams, Cleveland, OH (US)

Correspondence Address: CALFEE HALTER & GRISWOLD, LLP, 800 SUPERIOR AVENUE, SUITE 1400, CLEVELAND, OH, 44114, US

(73) Assignee: SWAGELOK COMPANY, SOLON, OH (US)

(21) Appl. No.: 11/547,296

(22) PCT Filed: Feb. 6, 2006
(86) PCT No.: PCT/US06/03909

§ 371 Date: May 13, 2008

Related U.S. Application Data
(60) Provisional application No. 60/652,631, filed on Feb. 14, 2005.

(51) Int. Cl. F16L 19/04

(52) U.S. Cl. 285/94

(57) ABSTRACT

A union in which a conduit is joined to a fitting so as to form a contact zone of high gripping pressure between the wall of the conduit and an engaging surface of the fitting, this contact zone being outboard of the region of highest stress formed in the wall of the conduit, an open volume being formed in the union adjacent this contact zone, the fitting including an abundance of liquid lubricant in at least a portion of this open volume.

### RELATED APPLICATIONS

This application claims the benefit of U.S. Provisional patent application Ser. No. 60/652,631 filed on Feb. 14, 2005 for Fitting with Lubricated Ferrule, the entire disclosure of which is fully incorporated herein by reference.

### BACKGROUND

FIG. 1 illustrates a conduit fitting in which the conduit-gripping ferrule makes a cut into the surface of the conduit such as shown in U.S. Pat. No. 2,179,127, the disclosure of which is incorporated herein by reference. In this particular fitting, ferrule 7 also includes a recess 12 formed in the portion of the ferrule's surface contiguous with its leading or “cutting” edge 10. With this design, the portion 14 of ferrule 7 adjacent recess 12 bows or arches away from conduit 3 when a nut (not shown) is tightened on fitting body 1. This tightening is commonly known as “pull-up” of the fitting. As a result, cutting edge 10 bites into the surface of conduit 3 thereby forming a fluid-tight seal at shoulder 13.

FIG. 2 illustrates another such fitting, i.e., a fitting in which the conduit-gripping ferrule makes a cut into the surface of the conduit, which utilizes two ferrules. See, for example, U.S. Pat. No. 6,629,708 B2 (the “'708 patent”), the disclosure of which is also incorporated herein by reference. Although the particular fitting shown in this patent is a two-ferrule fitting, the technology of this patent is applicable to single ferrule fittings as well.

FIG. 2 herein for clarity only illustrates the rear ferrule of such a fitting. The rear ferrule 27 of FIG. 2 includes a recess 32 in its interior surface, i.e. its surface facing conduit 23. However, in this instance, recess 32 is located outboard of cutting edge 30 (i.e. axially downstream of cutting edge 30 with respect to the end of the conduit), thereby leaving a cylindrical zone or contact area 43 near or adjacent this cutting edge. See, col. 5, lines 2 to 6 of the '708 patent. In addition, ferrule 27 can optionally be provided with an increasing annular wall thickness “t” in the region adjacent recess 32 for affecting the way the ferrule plastically deforms. See, col. 5, lines 24 to 47 of this patent. Other geometries are taught in the '708 patent including ferrules that do not use the interior recess or the tapered outer wall. In all the embodiments, a “hinging” effect is created when the fitting is tightened whereby the portion 43 of ferrule 27 is radially directed towards conduit 23 as the back end rotates away from the conduit. This toggle-like hinging action produces a swaged region or “colleting zone” 49 of high frictional engagement between the ferrule and the conduit wall.

This high frictional engagement creates an enhanced radially inward gripping pressure in colleting zone 49. This pressure isolates any outboard vibrations that may be imparted to conduit 23 from the area of the shoulder 33, which is the bite area where the stress imparted by the ferrule on conduit 23 is the highest, i.e. the so-called “stress riser region” of the conduit. The overall result is that the effect of conduit vibration can be substantially reduced with this design even for case hardened ferrules used to grip hard tubing. See, FIG. 28 and col. 5, line 66 to col. 6, line 58 of the '708 patent. For example, fittings of this type have shown a ten-fold increase in fatigue cycle life compared with conventional “bowing” bite-type fittings.

### SUMMARY OF THE INVENTION

In accordance with the present invention, it has been found that the effect of conduit vibration on the unions formed from fittings defining zones of high frictional engagement can be substantially reduced even more by including an abundance of liquid lubricant in the union.

Thus, the present invention provides a union in which a conduit is joined to a fitting so as to form a contact zone of high frictional engagement between the wall of the conduit and an engaging surface of the fitting, this contact zone being outboard of the region of highest stress formed in the wall of the conduit, an open volume being formed in the union adjacent this contact zone, the fitting including an abundance of liquid lubricant in at least a portion of this open volume.

### BRIEF DESCRIPTION OF THE DRAWINGS

The present invention may be more readily understood by reference to the following drawings wherein:

FIG. 1 is schematic view, partly in cross-section, illustrating a bite-type fitting such as shown in U.S. Pat. No. 2,179,127;

FIG. 2 is schematic view, partly in cross-section, illustrating a collating deformation grip-type fitting such as shown in FIGS. 2-28 of U.S. Pat. No. 6,629,708 B2, i.e., the '708 patent;

FIG. 3, which is a replication of FIG. 28 of the '708 patent, is a finite element analysis (“FEA”) illustrating the present invention when applied to a colleting deformation grip-type fitting such as shown in FIGS. 2-28 of that patent; and

FIGS. 4 and 4A are schematic representations of a portion of the fitting shown in FIGS. 2 and 3 illustrating an abundance of lubricant being present adjacent the contact zone in accordance with the present invention, FIG. 4 showing the fitting when in a finger-tight condition and FIG. 4A showing the fitting after pull-up; and

FIGS. 5 and 5A are schematic representations similar to FIGS. 4 and 4A illustrating the present invention when used in connection with a non-recess bite-type fitting, i.e., a bite-type fitting not including a recess 12 or 32.

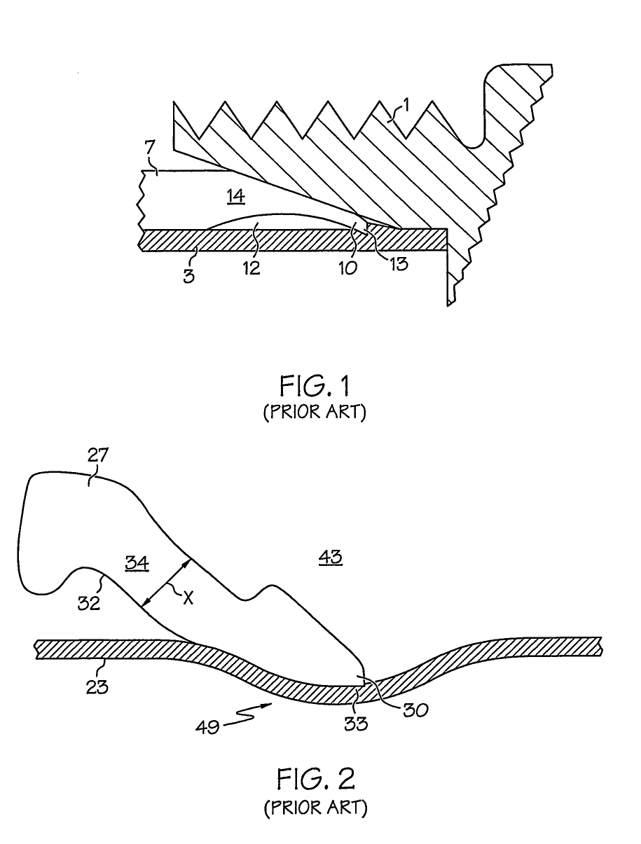

### DETAILED DESCRIPTION

### Terminology

For convenience, a fitting of the type in which a zone of high frictional engagement is created outboard of a bite-induced stress riser region in the conduit will be referred to as a “collating deformation grip-type” fitting.

Also, for the purposes of this disclosure, “conduit,” “tube” and “pipe” shall be taken as being synonymous with one another, unless otherwise indicated in specific instances. In this regard, the difference between “pipe” and “tube” is basically one of nomenclature and convention arising for historical reasons. In particular, “pipe” was the term traditionally used to refer to conduit having particular inside diameters, while “tube” was the term traditionally used to refer to conduit having particular outside diameters. Thus, “2 inch pipe” was understood as referring to a conduit having a 2 inch inside diameter, while “2 inch tube” was understood as referring to a conduit having a 2 inch outside diameter. Wall thicknesses may also have been different. Later, the convention regarding “pipe” changed so as to as to standardize on fixed outside diameters as well. Today, pipes and tubes are made by the same processes and have the same structure. Therefore, “conduit” is used herein to refer to both pipes and tubes, unless otherwise indicated. Finally, “union” is used herein to refer to the combination of a conduit and a fitting, not just the fitting.

### The Fittings

The present invention is broadly applicable to any fitting in which a contact zone of high gripping pressure is created outboard of the region of highest stress imparted to the wall of the conduit to which the fitting is joined.

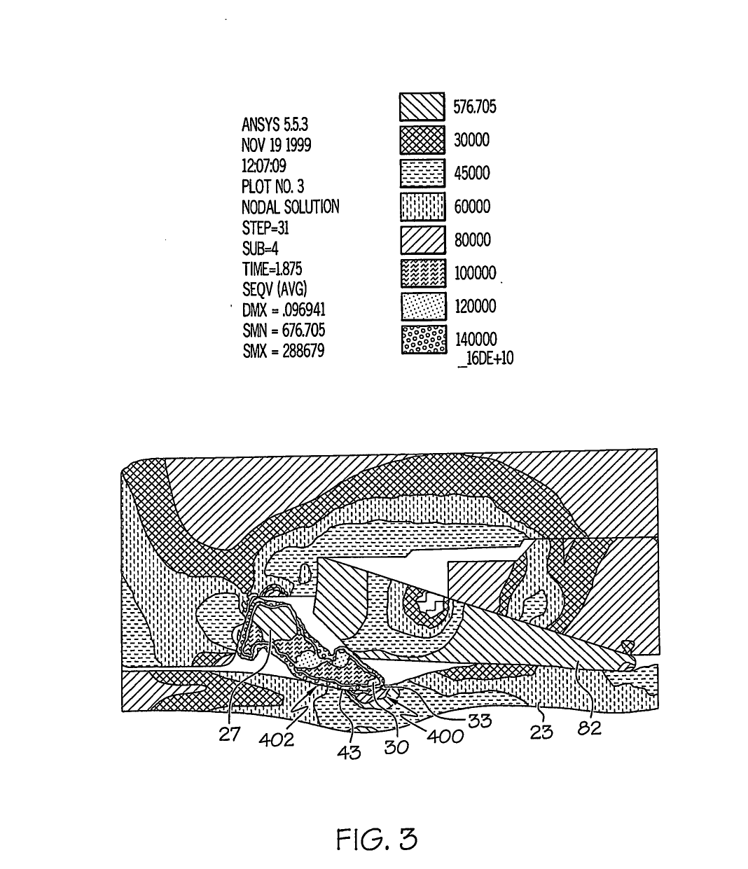

This may be most easily understood by reference to FIG. 3, which is a finite element analysis illustrating the stress imparted by the rear ferrule 27 of a colleting deformation grip-type fitting on the wall of a conduit 23 to which this fitting is pulled up. During pull-up, nose or cutting edge 30 of ferrule 27 forms a shoulder 33 in the wall of conduit 23, as explained above in connection with FIG. 2. This creates a small, localized region 400 in the vicinity of shoulder 33 where the stress imparted to the wall of conduit 23 is highest, i.e. the so-called “stress riser region” of the conduit. Ferrule 27 includes a contact area 43 outboard of this cutting edge, i.e. downstream with respect to the end of the conduit being joined. Because of the geometry of ferrule 27, the camming action of ferrule 27 caused by front ferrule 82 causes this contact area to be forced into intimate contact with the wall of conduit 23 at a very high pressure in localized contact zone 402. This high pressure, although not as high as the pressure in stress riser region 400, is nonetheless higher than in surrounding regions of the wall of conduit 23.

It will therefore be understood that, in the context of this case, a “region of highest stress formed in the wall of the conduit” refers to areas like region 400 where the stress imparted to the wall of the conduit being joined by the fitting is at its highest. Similarly, a “contact zone of high gripping pressure” means an area of the conduit wall such as zone 402 where the stress exerted by the fitting, while not necessarily at the highest level, is nonetheless still higher than that at generally surrounding areas of conduit wall.

As indicated above, the present invention is applicable to any fitting in which a contact zone of high gripping pressure is created outboard of the region of highest stress imparted to the wall of the conduit to which the fitting is joined. Most desirably, the present invention is applied to collating deformation grip-type fittings such as illustrated in the above FIGS. 2 and 3 and also in FIGS. 2-28 of the '708 patent in which a cutting edge 30 (FIG. 2 herein) formed by the nose of a ferrule bites into the wall of the conduit, with the shape of the ferrule being such that a contact zone 402 of high pressure is formed outboard of region 400 of highest pressure.

In addition, the present invention is also applicable to other fittings using multiple ferrules and/or gripping rings, as well as fittings based on a single ferrule or gripping ring. For example, the present invention is also applicable to the single ferrule type fittings shown in WO 02/063194 and WO 02/063195, the disclosures of which are also incorporated herein by reference.

### Abundance of Lubricant

In accordance with the present invention, it has been found that the effects of conduit vibration on unions defining contact zones of high gripping pressure can be substantially reduced by including in the union an abundance of liquid lubricant.

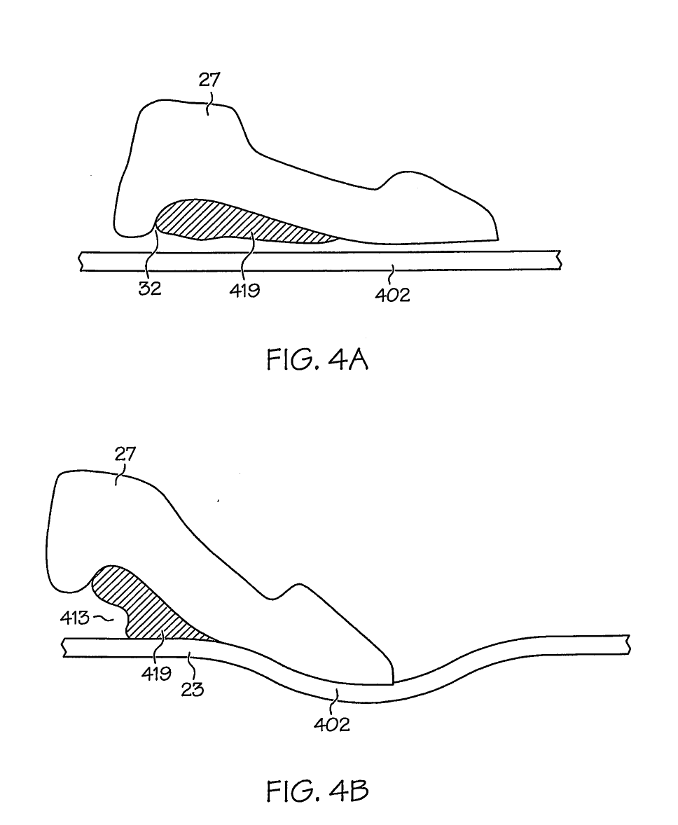

This is illustrated in FIGS. 4 and 4A, which are schematic representations showing the interaction of the rear ferrule 27 of the two-ferrule fitting illustrated in FIGS. 2 and 3 and the wall of conduit 23, both in a finger-tight condition before pull-up (FIG. 4) and after pull-up (FIG. 4A). As shown in FIG. 4A, when pull up of the fitting is complete (i.e. when the fitting is fully tightened), open volume or annular space 413 is formed between conduit 23 and ferrule 27 outboard of and in fluid communication with contact zone 402.

In accordance with the invention, liquid lubricant is applied so that at least some and possibly all of open volume or annular space 413 is filled with liquid lubricant 419. Fittings of the type illustrated here are most commonly used for joining conduits having diameters on the order of ¼, ½, ¾, 1 and 2 inches. Such conduits typically have wall thicknesses on the order of about 0.028-0.188 inch. When a fitting is joined to such a conduit, annular space 413 produced thereby is comparatively small in depth, typically no more than this wall thickness or even less. In accordance with the invention, a liquid lubricant is applied so that this annular space is substantially filled, and more typically essentially completely filled, with the lubricant.

This can be done with most liquid lubricants by applying a generous amount of lubricant to the portions of the conduit defining contact zone 402 and annular space 413, for example, by dipping the conduit end into a reservoir of the lubricant and/or coating with an excess of the lubricant such as with a brush or sprayer, and then sliding ferrule 27 into position. Additional lubricant can also be applied after the ferrule is slid into place, if desired. As illustrated in FIG. 4 which shows the union before pull-up, this will normally cause lubricant 419 to be received in recess 32 formed in the interior surface of ferrule 27. This will also cause a layer or film of lubricant (not shown) to be present between the wall of conduit 23 and the engaging surface of ferrule 27 in at least some and usually all of contact zone 402. Final tightening of the fitting (pull-up) will then cause the lubricant in recess 32 to substantially and/or essentially completely fill annular space 413 formed by the pull-up operation, at least in most situations, because the open volume defined by this annular space is so small.

Thus it will be appreciated that, in the context of this case, applying an “abundance” of liquid lubricant means that enough lubricant is applied to the components of the union so that, after pull up, a substantial amount of open volume 413 (whether inboard or outboard of the contact zone) is filled with lubricant. Usually, a majority of this open volume will be filled.

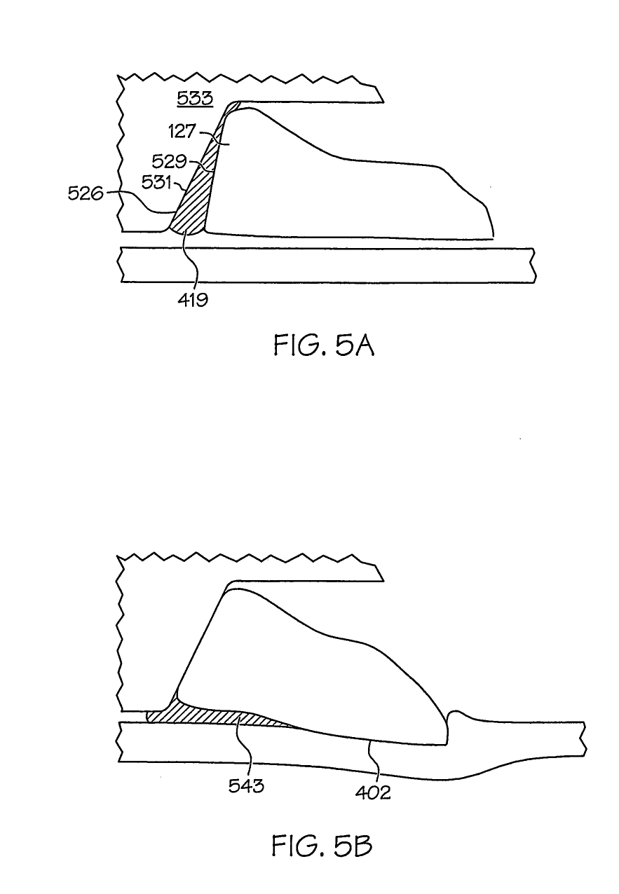

FIGS. 5 and 5A illustrate another embodiment of the present invention in which a non-recess colleting deformation grip type fitting is provided with an abundance of liquid lubricant. The fitting of this embodiment is similar to that of FIGS. 2, 3, 4 and 4A except that, in this embodiment, there is no recess 32 (FIG. 2) in ferrule 127 before pull-up. Accordingly, when ferrule 127 is slid into position, before pull-up as shown in FIG. 5, lubricant fills some or all of recess 526 defined between the outbound edge 529 of ferrule 127 and the corresponding engaging or camming surface 531 of nut 533. Then, as a result of final tightening, this lubricant moves into recess 543 adjacent contact zone 402, which recess also forms as a result of the final tightening process. In accordance with the present invention, an abundance of lubricant also fills open volume 543 adjacent contact zone 402, just as in the previous embodiment.

### Lubricant Application

The manner in which an abundance of lubricant is provided to the union is not critical and any technique can be used. For example, the lubricant can be applied to one, some or all of the components forming the union (i.e. the conduit, ferrules and/or or gripping rings) by dipping, spraying, coating, rolling, brushing or like application technique before the components are assembled. In addition, the lubricant can be applied after the parts are at least loosely assembled together, before or after finger tightening, so long as there is sufficient relative movement during final assembly and/or pull up so that an abundance of lubricant moves into open volume 413.

Note, also, that the amount of lubricant applied can be controlled by combining the lubricant with a suitable carrier and then allowing the carrier to evaporate after lubricant application. For example, lubricants can be combined with organic solvents such as mineral oil and other suitable petroleum distillates or they can be emulsified in water for this purpose. Carrier/lubricant weight ratios in such compositions can vary widely and any such ratios can be used. Typically, carrier/lubricant ratios as high as about 10/1 can be used, although ratios of about 5/1 or less, more typically about 4/1 or less, or 3/1 or less, 2/1 or less, 1/1 or less, 0.5/1 or less, etc. can be used. Of course, no carrier at all can also be used. Additives for increasing viscosity can also be used for providing thicker layers of applied lubricant, and hence more lubricant after pull up. Regardless of the application technique used, however, enough liquid lubricant should be applied so that, after pull-up, an abundance of lubricant is present.

### The Lubricant

Essentially any material which is liquid (i.e. capable of flowing as a result of gravity) under the conditions that the fitting union will be used, and which functions as a lubricant under these conditions (i.e., which decreases the coefficient of friction between the engaging surfaces of the of the conduit and ferrule or gripping ring in contact zone 402) can be used as the lubricant in the present invention. Examples include mineral oils, oils derived from coal tar or shale, vegetable oils, animal oils, hydrocracked oils especially hydrocracked paraffinic oils, synthetic oils or mixtures thereof. Examples of synthetic oils include hydroisomerized paraffins, polyalphaolefins, polybutene, alkylbenzenes, polyglycols, esters such as polyesters of dibasic carboxylic acid esters, alkylene oxide polymers, silicone oils and the like. Such oils can be used neat (i.e., as is) or they can be provided with various additives well known in the lubricant industry such as extreme pressure agents, wear-reduction agents, friction modifiers dispersants, antioxidants, detergents, anti-foam agents, and the like. Particular examples are various oil-soluble molybdenum compounds such as molybdenum dithiocarbamate, various oil-soluble phosphorous compounds, various oil-soluble zinc compounds such as zinc dialkyldithiophosphate (“ZDDP”) and the like.

Liquid lubricants of particular interest are those that exhibit good heat resistance such as those made with the base stocks used to formulate internal combustion engine motor oils, silicone oils and the like. Thus, materials meeting the specifications for Group I, Group II, Group III, Group IV or Group V base oils of the API Base Oil Interchange Guidelines can be used. Liquid lubricants made from petroleum-derived base oils containing at least about 70 wt. %, more typically at least about 80 wt. %, and especially at least about 90 wt. %, paraffins are interesting. Liquid lubricants made from highly paraffinic base oils having iodine numbers of less than 9, less than 4 and even less than 1, as determined by ASTM D 460, are especially interesting.

Examples of particular lubricants been found useful in accordance with the present invention include hydrotreated mineral oils such as the Parpreme line of severely hydrotreated paraffinic process oils available from Universal Oil, Inc. of Cleveland, Ohio, and especially Parpreme Heavy; the Shellflex® line of hydrotreated residual oils available from Shell Oil Company of Houston, Tex., and especially Shellflex® 2790; the Mobil DTE 20 Series of petroleum hydrocarbon hydraulic oils available from Exxon Mobile Corporation of Fairfax, Va., and especially, Mobil DTE 26; the Mobil Vacuoline® 100 Series of solvent refined base oils available from Exxon Mobile Corporation of Fairfax, Va. and especially Mobil Vacuoline® 146; and the line of WOCO mineral oils available from Wallover Oil Company of Strongsville, Ohio, and especially WOCO Supreme 2600. Castor oil, which is a triglyceride of ricinoleic acid, can also be used as can castor oil filled with metallic silver flake.

The viscosity of the liquid lubricant is not critical and, basically, liquid lubricants of any viscosity can be used. Normally, however, the liquid lubricant will have a viscosity from about 1 to 10,000 cSt@40° C., more typically about 200 to 1,000 cSt@40° C. and especially about 440 to 500 cSt@40° C.

### EXAMPLES

In order to more thoroughly describe the present invention, the following working examples are provided.

In each example, a 24 inch conduit made from AISI 316L stainless steel and having an outside diameter of ¼ to ¾ inch was joined to a collet deformation grip-type two-ferrule fitting of the type illustrated in FIGS. 2, 3, 4 and 4A above and the fretting fatigue resistance of the conduit determined. This was done by fixing the fitting in a jig and vibrating the remote end of the conduit at a frequency of about 3,500 full cycle vibrations per minute, a total alternating stress of 31 ksi and a total alternating strain of 0.0011 inch and then determining the total number of vibration cycles that occurred before conduit failure.

In a first comparative example, no lubricant was applied to the conduit or fitting. In a second group of comparative examples, solid or semisolid lubricants were applied by various different application techniques including electroplating, low temperature carburization and simple physical application in the case of lubricants having a wax and/or grease-like consistency. In a third group of comparative experiments, liquid lubricants were sparingly applied to the rear ferrule of the fitting by dipping the ferrule into the lubricant and then spinning the ferrule in a centrifuge to remove excess lubricant. In some of these examples, the thickness of the lubricant coating was further controlled by combining the lubricant with mineral oil as a carrier. In a final group of experiments, liquid lubricants were generously applied so as to achieve an abundance of lubricant in annular space 413 outboard of this contact zone. This was done by brushing and/or spraying the lubricant (without dilution with a carrier) onto the conduit in the region of contact zone 402 and annular space 413 and then sliding the rear ferrule into position followed by pull-up.

The thickness of the lubricant coating in the comparative examples was determined by a direct oxidation carbon coulometer before the components of the union were assembled. Finally, each example was carried out a number of times for developing more accurate data.

The different lubricants that were tested are identified in the following Table 1:

TABLE 1
Lubricants

| | |
|---|---|
| None | No lubricant or other surface treatment was used |
| Ag Paste | Castor Oil containing about 28 wt. % silver metal flake |
| BN | A boron nitride dry powder was applied between ferrule and |
| | tube immediately before pull-up. |
| Oxide | An oxide surface layer produced in the manner described in |
| | U.S. Pat. No. 6,547,888 was formed on the ferrule |
| Shellflex | Shellflex ® 2790—A hydrotreated residual oil having a |
| | viscosity of about 494 cSt. @ 40° C. available from |
| | Shell Oil Company of Houston, Texas |
| Parpreme | Parpreme Heavy—A severely hydrotreated paraffinic process |
| | oil having a viscosity of about 448 cSt. @ 40° C. available |
| | from Universal Oil, Inc. of Cleveland, Ohio |
| WOCO | WOCO Supreme 2600—A petroleum distillate (mineral oil) |
| | having a viscosity of about 481 cSt. @ 40° C. available from |
| | Wallover Oil Company of Strongsville, Ohio |
| Cast Oil | C. P. Castor Oil—A highly refined castor oil product having a |
| | viscosity of about 6.3-6.8 Stokes @ 25° C. available |
| | from The York Castor Oil Company of Westfield, New Jersey |
| Ag Paste | Silver Paste—Castor Oil filled with about 30 wt. % silver |
| | metal flake and about 15 wt. % of other solid lubricants. |
| Ag Plate | Silver Plate—A solid layer of metallic silver was electroplated |
| | onto the ferrule |
| Wax | A blend of various petroleum waxes |
| DTE 26 | A petroleum hydrocarbon having a viscosity of about 71 |
| | cSt. @ 40° C. available from Exxon Mobile Corporation |
| | of Fairfax, Virginia |
| Vac 146 | Vacuoline 146—Solvent refined base oil having a viscosity of |
| | about 448 cSt. @ 40° C. available from Exxon Mobile |
| | Corporation of Fairfax, Virginia |

The results obtained are set forth in the following Table 2:

TABLE 2
Cycles Until Failure

| | Conduit | | | | | | | Ave Cycles |
|---|---|---|---|---|---|---|---|---|
| | | Wall | | Solvent/ | Ave Lub | | Abun- | Until |
| | Diam, | Thick, | | Lubricant | Thickness | No of | dance | Failure |
| Ex. | in. | in | Lubricant | ratio | (μ in) | Samples | of Lub? | (000's) |
| Grp 1 | | | | | | | | |
| A | ½ | 0.035 | None | | NA | 8 | | 322 |
| Grp 2 | | | | | | | | |
| B | ½ | 0.035 | Ag Plate | | ~0.0001 in | 2 | N | 624 |
| C | ½ | 0.035 | BN | | >0.005 in | 2 | N | 482 |
| D | ½ | 0.035 | Oxide | | NA | 2 | N | 548 |
| Grp 3 | | | | | | | | |
| E | ¼ | ~0.06 | Shellflex | 3/1 | 10-30 | 18 | N | 1,052 |
| F¹ | ½ | 0.035 | Shellflex | 3/1 | 10-30 | 10 | N | 995 |
| G² | ½ | 0.035 | Shellflex | 3/1 | 10-30 | 8 | N | 2,384 |
| H³ | ½ | 0.035 | Shellflex | 3/1 | 10-30 | 9 | N | 2,276 |
| I | ¾ | 0.049 | Shellflex | 3/1 | 46 | 7 | N | 996 |
| J | ¾ | 0.049 | Parpreme | 4/1 | 19 | 6 | N | 1,373 |
| K | ¾ | 0.049 | Parpreme | 2/1 | 41 | 6 | N | 1,519 |
| L | ¾ | 0.049 | Parpreme | 4/3 | 52 | 6 | N | 963 |
| M | ¾ | 0.049 | Parpreme | neat | 230 | 6 | N | 3,889 |
| N | ¾ | 0.049 | DTE 26 | neat | 88 | 2 | N | 1,310 |
| O | ¾ | 0.049 | Vac 146 | 1.5/1 | 48 | 2 | N | 2,311 |
| Grp 4 | | | | | | | | |
| 1 | ½ | 0.035 | Parpreme | neat | — | 4 | Y | 18,468 |
| 2 | ½ | 0.035 | WOCO | neat | — | 4 | Y | 10,061 |
| 3 | ¼ | 0.065 | Shellflex | neat | — | 2 | Y | 7,764 |
| P | ½ | 0.035 | Ag Paste | neat | — | 8 | Y | 4,089 |
| 4 | ¼ | 0.060 | Cast Oil | neat | — | 2 | Y | 1,930 |
| Q | ½ | 0.035 | Wax | neat | — | 4 | Y | 489 |

¹Conduit Hardness = 75 RB
²Conduit Hardness = 87 RB
³Conduit Hardness = 89 RB

From Table 2, it can be seen that the fatigue cycle life of each union made with a lubricant being provided in the colleting zone 402 formed between the conduit and the rear ferrule of the fitting, as measured by the cycles until failure, increased significantly relative to the same fitting when lubricant was absent from this zone. Moreover, when an abundance of a liquid lubricant was included in the open volume adjacent this colleting zone, (i.e., annular space 413), particularly good results were obtained (Examples 1-4), especially when heat-resistant lubricants were used (Examples 1-3). Compare, for example, Example 1 (18,468,000 cycles until failure) with Comparative Example A in which no liquid lubricant was used (322,000 cycles until failure), as well as Comparative Example M in which the same lubricant was used but not in abundance (3,889,000 cycles until failure).

It will therefore be appreciated that, in accordance with the present invention, the fatigue cycle life of such fittings can be increased substantially (i.e. by a factor of at least 2) compared with otherwise identical unions not including an abundance of liquid lubricant. Indeed, the cycle life of Example 1 was some 4½ times greater than that of Comparative Example M in which a non-abundant amount of the same lubricant was used and some 57 times greater than that of Comparative Example A in which no lubricant was used. This shows that the fatigue cycle life of fittings defining contact zones of high gripping pressure can be easily be increased through the present invention by factors of 5, 10, 20, 30 or even 50 or more compared with otherwise identical unions not including a liquid lubricant.

Although only a few embodiments of the present invention have been described above, it should be appreciated that many modifications can be made without departing from the spirit and scope of the invention. All such modifications are intended to be included within the scope of the present invention, which is to be limited only by the following claims.

1. A union in which a conduit is joined to a fitting so as to form a contact zone of high gripping pressure between the wall of the conduit and an engaging surface of the fitting, this contact zone being outboard of the region of highest stress formed in the wall of the conduit, an open volume being formed in the union adjacent this contact zone, the fitting including an abundance of liquid lubricant in at least a portion of this open volume.

2. The union of claim 1, wherein liquid lubricant is applied to one or more components of the union so that, upon pull-up, liquid lubricant will be present between the wall of the conduit and the engaging surface of the fitting in at least a portion of this contact zone.

3. The union of claim 2, wherein the contact zone is adjacent the region of highest stress and further wherein the open volume is adjacent the contact zone

4. The union of claim 3, in which the fitting of the union is a bite-type fitting.

5. The union of claim 3, in which the fitting of the union is a colleting deformation grip-type fitting.

6. The union of claim 5, wherein the colleting deformation grip-type fitting is a two ferrule fitting having a front ferrule and a rear ferrule, the rear ferrule having a nose which engages the wall of the conduit thereby forming the region of highest stress in the wall of the conduit after pull-up, wherein contact zone is formed by the rear ferrule, and wherein the rear ferrule and the conduit after pull-up define an annular space outboard of the contact zone, this annular space containing the abundance of lubricant.

7. The union of claim 1, in which the lubricant is a mineral oil, an oil derived from coal tar or shale, a vegetable oil, an animal oil, a hydrocracked oil, a synthetic oil or mixtures thereof.

8. The union of claim 7, in which the lubricant is a synthetic oil selected from the group consisting of hydroisomerized paraffins, polyalphaolefins, polybutene, alkylbenzenes, polyglycols, polyesters of dibasic carboxylic acid esters, alkylene oxide polymers, silicone oils and mixtures thereof.

9. The union of claim 8, in which the lubricant is made from a petroleum-derived base oil.

10. The union of claim 9, in which the petroleum-derived base oil contains at least about 70 wt. % paraffins.

11. A union in which a conduit is joined to a fitting so as to form a contact zone of high gripping pressure between the wall of the conduit and an engaging surface of the fitting, this contact zone being outboard of the region of highest stress formed in the wall of the conduit, an open volume being formed in the union adjacent this contact zone, the fitting including sufficient liquid lubricant in this open volume to increase the fatigue cycle life of the union by a factor of at least two relative to an otherwise identical union not including any lubricant.

12. A process for increasing the fatigue cycle life of a union between a conduit and a fitting in which a contact zone of high gripping pressure is created upon pull-up between the wall of the conduit and an engaging surface of the fitting, this contact zone being outboard of the region of highest stress formed in the wall of the conduit, an open volume being formed in the union adjacent this contact zone,
the process comprising including an abundance of liquid lubricant in at least a portion of this open volume.

13. The union of claim 1 wherein a substantial amount of the open volume is filled with the lubricant.

14. The union of claim 1 wherein a majority of the open volume is filled with the lubricant.

15. The union of claim 1 wherein all of the open volume is filled with the lubricant.

16. The union of claim 1 wherein the open volume is formed between a ferrule of the fitting and the conduit.

17. The union of claim 16 wherein a substantial amount of the open volume is filled with the lubricant.

18. The union of claim 16 wherein a majority of the open volume is filled with the lubricant.

19. The union of claim 16 wherein all of the open volume is filled with the lubricant.

20. The process of claim 12 wherein a substantial amount of the open volume is filled with the lubricant.

21. The process of claim 12 wherein a majority of the open volume is filled with the lubricant.

22. The process of claim 12 wherein all of the open volume is filled with the lubricant.
